(19) United States
(12) Patent Application Publication
(10) Pub. No.: US 2011/0150744 A1
(43) Pub. Date: Jun. 23, 2011

(54) Method for Drying Potash

(75) Inventors: Michael Edward Prokesch, Coopersburg, PA (US); Steven Andrew Ciccarelli, Pen Argyl, PA (US)

(73) Assignee: FLSMIDTH A/S, Valby (DK)

(21) Appl. No.: 12/644,064

(22) Filed: Dec. 22, 2009

(51) Int. Cl. C01D 7/22; C01D 1/04

(52) U.S. Cl. 423/421; 423/641

(57) ABSTRACT

A process for drying potash in which wet potash is introduced into a vertical gas suspension column, in which it is entrained in a heated gas and dried from an initial moisture content of from about 3 to about 6 wt. percent to about 0.01 to about 0.1 wt. percent.

### FIELD OF THE INVENTION

This invention relates to drying potash in a gas suspension apparatus and process. In one aspect, this invention relates to a process for drying potash that is both energy efficient and overcomes many of the disadvantages of prior art potash drying processes.

### BACKGROUND OF THE INVENTION

Potassium is one of the three basic plant nutrients along with nitrogen and phosphorus. There is no substitute for potassium compounds in agriculture; they are essential to maintain and expand food production. The term potash, in a narrow sense, refers to the salt potassium carbonate (K₂CO₃). In a broader sense and in accordance with it's definition in the context of the present invention, it is a generic term for various water-soluble potassium salts that may be mined or manufactured. Potash is extracted from buried evaporites by underground or solution mining. This accounts for most of the potash produced.

Today, potash (in the form of potassium oxide) is used mainly as a fertilizer. About 95% of potash produced worldwide is used in agriculture. The rest is found in several other industrial uses, including glass manufacturing, soaps, plastics and pharmaceuticals.

About 70% of the total of potash, and almost 90% of fertilizer grade potassium chloride, is produced by conventional froth flotation, sometimes supplemented by heavy media separation. Crystallization is used mainly to produce industrial grade and specialty fertilizer grade (white muriate) potash. Screen bowl centrifuges are usually used to dewater and de-brine the flotation concentrates after which they are dried.

Commercial demands dictate that in the drying process the moisture content of potash must be reduced from an initial moisture content of from 1 to about 10 weight percent, and more typically from about 3.0 to about 6.0 percent to a dried product having a final moisture content of from about 0.5 to 0.01 weight percent, and more typically from about 0.1 to about 0.01 percent, depending upon the initial moisture content and the needs of the end user.

Because potash has a crystalline structure having a significant amount of captured interstitial water content, the popular belief was that drying processes that had significant retention times were required to dry potash to commercially acceptable levels. Thus, for many years both rotary and fluid bed dryers have been commonly used to dry potash.

Most rotary dryers are direct fired. Rotary dryers are slightly inclined cylindrical shells supported by riding rings on sets of rollers. Although commonly used to dry potash, rotary dryers have a number of disadvantages, including (a) high off gas temperature; (b) need for frequent maintenance of the rotating components; (c) a comparatively large foot print in the plant; (d) a higher capital cost; (e) less responsive to feed changes; (f) particle attrition; (g) comparatively high heat losses, and (h) a feed screw/chute prone to material buildup due to exposure to high gas temperatures.

The term “fluidized bed dryer” usually refers to a bed of finely divided solids supported on a grid through which a gas is passing. The introduction of an appropriate gas flow into the material bed brings about the onset of fluidization. Gases bubbling through the bed of material create a condition of rapid mixing. Although an alternative method to rotary dryers to dry potash, fluid bed dryers also have a number of disadvantages including (a) inlet temperature limited to 650° C. due to potassium chloride melting; (b) difficulties in fluidizing high moisture potash (>6 wt % H2O); (c) high power consumption; (d) nozzle blockages and deterioration; (e) particle attrition and (f) requiring skilled operating personnel. Moreover, the grid plate, in the fluid bed, is a place were sticking or caking of potash occurs and is also a source of refractory/material problems and cost. The nozzles on the grid plate can deteriorate due to corrosion, and subsequent failure can lead to material flow into the hot air plenum of the unit causing downtime.

It would therefore be advantageous to have an alternate method of drying potash that does not have the disadvantages of prior art drying methods.

### SUMMARY OF THE INVENTION

According to this invention, potash is dried in a gas suspension process that overcomes many of the disadvantages inherent in prior art drying processes.

In a first embodiment of the invention, potash feed is dried to a moisture content of about 0.1 to about 0.01 percent by weight in a gas suspension process. The dried potash is directed to a separation cyclone.

Although outside the scope of the present invention, typically after drying product is screened on double deck rotary screens into coarse, standard and fine product. Screened product is stored in bins for dispatch to customers or to further processing.

In a second embodiment of the invention a specified amount of dried product is recycled to mix with and condition the feed.

In another embodiment a specified amount of hot gas downstream from the separation cyclone is recycled to the vicinity of the gas suspension dryer inlet to reduce the dryer fuel consumption.

The present process is advantageous over prior art potash drying processes in that there is no moving components. Thus, the whole process can be made fully automatic requiring no handling, a minimum of human involvement, and reduced maintenance. The present process also benefits from having a reduced plant footprint and reduced equipment size, consequently, lower capital equipment costs. The process has a higher thermal efficiency over prior art processes and therefore results in a reduced consumption of fuel.

There is a much lower product residence time in the drying apparatus of the present invention, which translates into lower particle attrition (i.e., lower product fines), in that the amount of mechanical impacting of the crystalline particles during the drying process is greatly reduced. With specific reference to the prior art fluid bed drying process, there is no grid plate or nozzles or no equivalent structure that presents significant clogging or deterioration concerns.

Various embodiments of the invention are further described in the drawings in which like numerals are employed to designate like parts.

### BRIEF DESCRIPTION OF THE DRAWINGS

FIG. 1 is a schematic flow diagram of one embodiment of this invention.

FIG. 2 is a schematic flow diagram of another embodiment of this invention.

FIG. 3 is a schematic flow diagram of a third embodiment of this invention.

FIG. 4 is a schematic flow diagram of a fourth embodiment of this invention.

### DETAILED DESCRIPTION OF THE INVENTION

It should be understood at the outset that identical reference numbers on the various drawing sheets refer to identical elements of the invention. It should also be understood that the following description is intended to completely describe the invention and to explain the best mode of practicing the invention known to the inventors but is not intended to be limiting in interpretation of the scope of the claims. The drawings are not necessarily to scale, emphasis instead being placed upon illustrating principles of the invention.

Any conventional process can prepare the potash used in the practice of this invention, most preferably a flotation process, and the potash feed typically contain between about 3 and 6 percent by weight moisture. The feed may also contain amounts of undesirable organic residue.

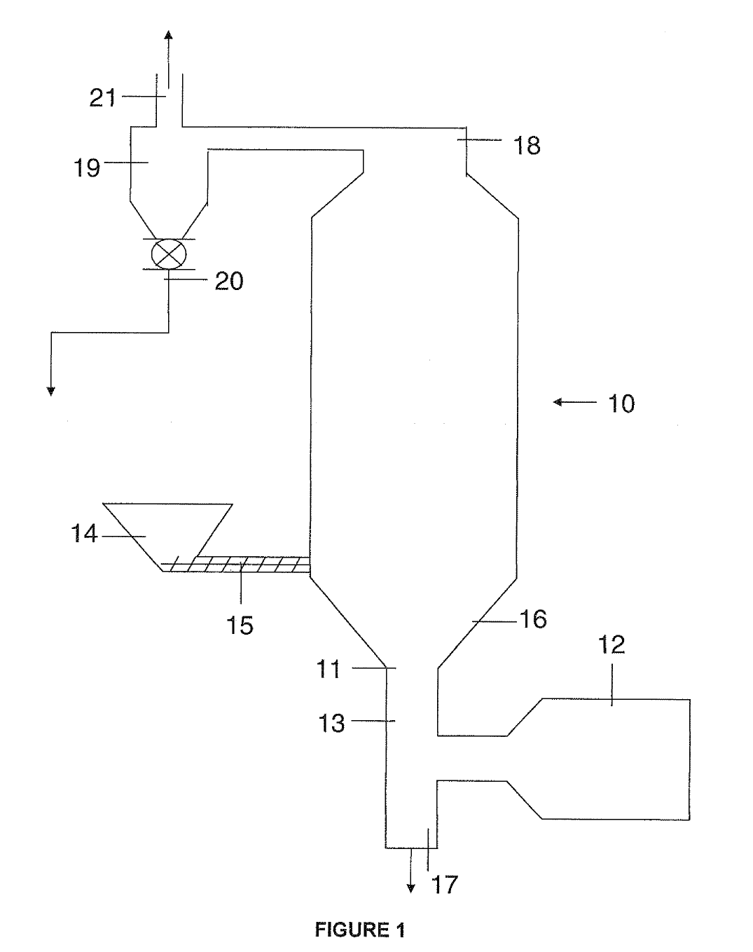

With reference to FIG. 1, there is a vertical gas suspension drying column 10, the air inlet end 11 of which is connected to a source of hot gases such as burner 12 which heats the air entering the column. The column in the example is constructed of refractory lined steel, although high temperature alloys and/or external insulation may also be employed. The column is heavily insulated to minimize heat loss through its sidewall. The temperature of the heated gas entering the column is selected to optimize the thermal efficiency of the process, and in general will range from about 450° C. to about 1200° C. and more preferably from about 650° C. to about 1200° C.

Both the vertical height and the interior diameter of the column are factors that will influence the residence time of material within the column. Typically the column is constructed so that the average residence time of the material in the column will range from about 0.25 to about 3 seconds and more preferably from about 0.5 to about 1.5 seconds. It has been surprisingly discovered that even with such brief residence times the potash is dried to a moisture content of about 0.1 to about 0.01 percent by weight.

The air velocity through the column may be varied by changing the dimensions of column, and the inlet velocity can be adjusted by changing the area of the optional venturi area 13 located downstream from inlet end 11. Typical air velocity in the column will range from 2 mps to 15 mps. The venturi throat velocity will typically range between 15-30 mps. The air velocity in the column 10 utilized will depend on factors such as the size range of the potash feed, particle density, the moisture content of the potash, the flow properties of the wet potash and the dispersion properties of the wet potash.

Potash having an moisture content ranging from about 3 to about 6% contained in bin or hopper 14 in the form of clumped material is discharged by way of screw feeder 15 into the lower area of vertical drying column 10 but above gas inlet 11. Any overly large clumps of potash which are not picked up by the flow of hot entraining gases will drop down toward the throat area, in which they will be entrained by the higher velocity gases, dried and consequently reduced in size by material ablation, entrained in hot gases and taken up into vertical drying column 10. In the event of a severe upstream upset condition resulting in very wet large clumps of feed that can not be entrained, even in the high velocity throat area, such feed particles can be periodically removed from the bottom of the drying column 10 through material clean out port 17 and recycled to hopper 14 for reinsertion into column 10 for further drying and size reduction.

Wet potash entering drying column 10 is quickly and substantially dried within the first few meters the material travels upward through column 10 while entrained in a hot gas. Upon removal of the surface moisture, the additional heat transfer and residence time in column 10 support the removal of inherent and interstitial water by the hot gases. The material loses moisture that is absorbed by the hot air, so the temperature of air reduces while its humidity increases. The material is entrained within the high velocity flow of the gases upwardly through the drying column 10 and is discharged through the outlet 18 into the outer collection cyclone 19, in which further drying takes place. Dried potash is gravity separated and will exit at cyclone outlet 20. The hot gas along with the fines, or smaller particles of potash, flows upwardly through duct 21 and enters a baghouse or other particulate collection device (not shown). Clean air is drawn out of baghouse and is directed to atmosphere. Airflow control devices (not shown) are used to ensure that airflow through the system is constantly maintained and that proper pressures are maintained within the dryer to avoid extreme pressure conditions (either positive or negative) in the system.

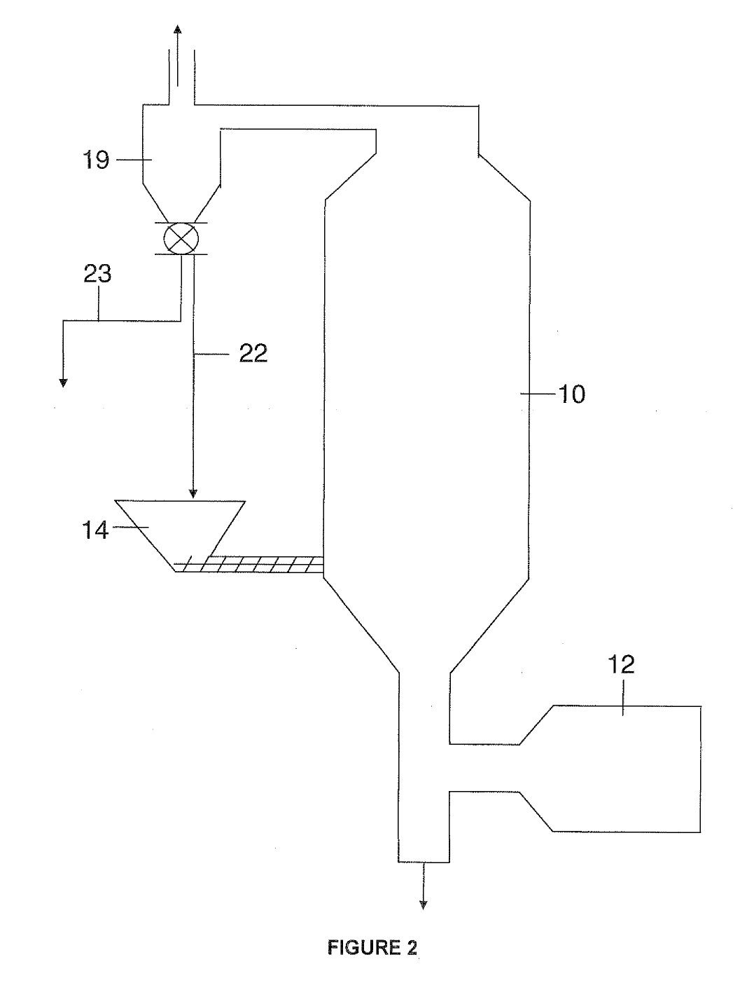

FIG. 2 depicts an optional embodiment of the present invention in which some product is recirculated to feed hopper 14 from cyclone 19 via recirculation duct 22. Recirculation will modify the flow properties of the wet potash with which said product is combined, thereby allowing for more effective dispersion of the particles into the drying column and optimal contact with the drying gases. Recirculation is employed in the event of high potash moisture levels greater than about 6% or in the event of an upset in the upstream de-watering circuit in which event the feature can be quickly activated to thereby convert a very wet and sticky potash that cannot be air entrained into a dispersible material stream. When employed, the amount of dry material recirculation typically ranges between about 10 to 100 percent of the actual feed input.

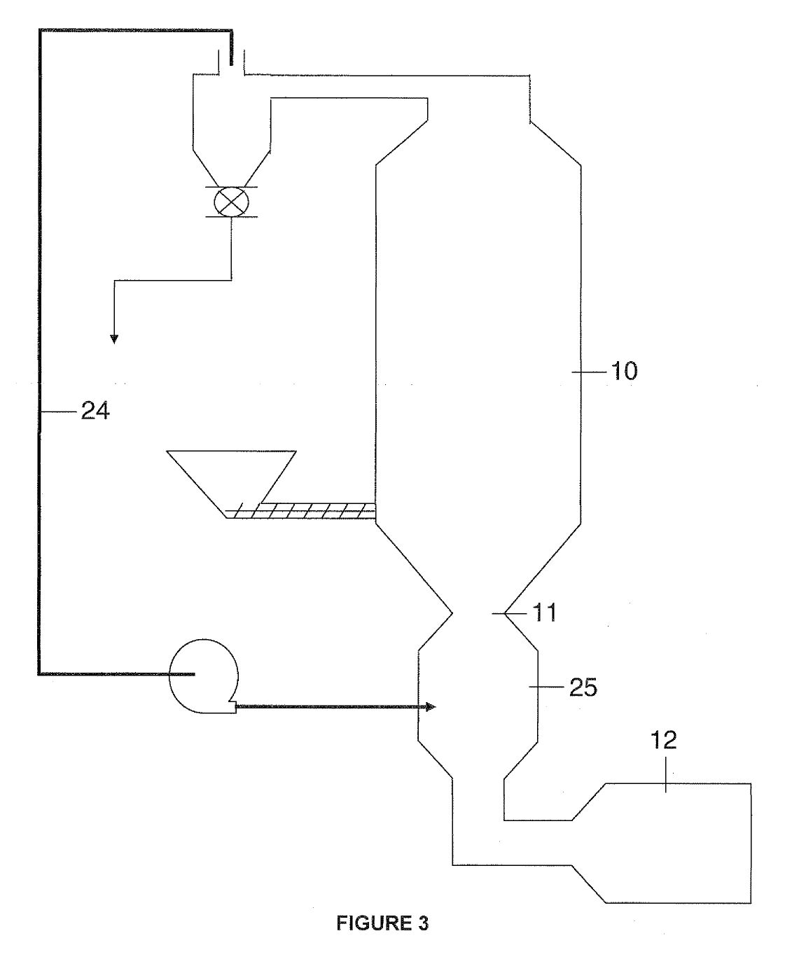

FIG. 3 depicts an optional embodiment of the present invention in which a portion of the dryer off gas exiting the cyclone or particulate filter is returned to the bottom inlet area 11 of dryer column 10 downstream of burner 12. This return of hot gases reduces the amount of cold air input to the system, thereby reducing the amount of fuel consumed. If the recirculated gases contain fine particles of potash a mixing chamber 25 may be positioned prior to the dryer column inlet 11 in order to introduce this gas into the dryer 10 in a manner that minimizes contact of the fines with the hot refractory surfaces of the dryer to thereby reduce buildup potential within the dryer.

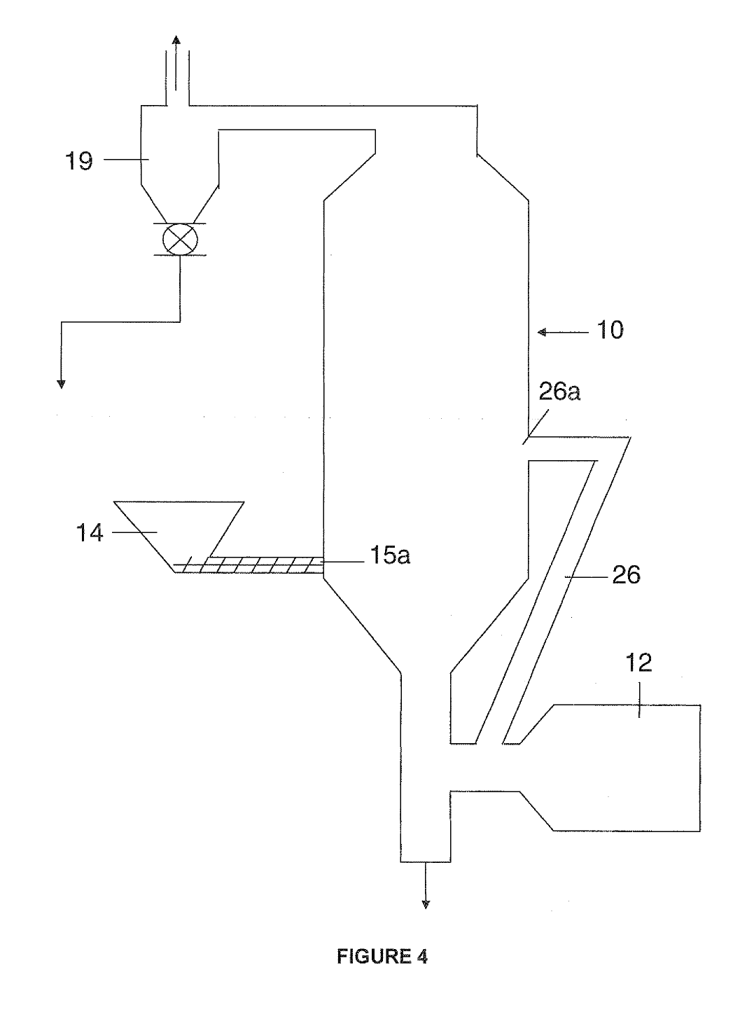

FIG. 4 shows another optional embodiment of the present invention in which a portion of the hot gas produced by the air heater is bypassed around the bottom of the drying column via duct 26 and introduced at a second point 26a further up along the drying column 10, typically above the area 15a where wet potash enters the drying column 10. This feature serves several purposes. First, it reduces the gas mass flow in the potash feed zone, which results in a more significant quenching of the inlet gases. This reduces the potential thermal shock to the particles and reduces the potential for hot column surfaces that may promote sticking. The second advantage is that the surface moisture is liberated in the lower drying column, and then the particles are exposed to the high temperature bypass gas. This exposure promotes rapid devolatilization of organic residues and subsequent combustion in order to reduce VOC emission levels and reduce the potential for VOC condensation in downstream particulate collection devices.

Although this invention has been described in detail by reference to the drawings, this detail is for illustration only, and it is not to be construed as a limitation upon the invention as described in the appended claims.

What is claimed is:

1. A process for drying potash comprising:
(i) introducing wet potash into a vertical gas suspension column near the bottom thereof,
(ii) transporting the potash upward through and out of the top of the gas suspension column in an entraining heated gas to thereby dry the potash, said heated gas entering the vertical gas suspension column through a gas inlet located near the bottom of the vertical gas suspension column and below where the material enters the column.

2. The process of claim 1 further comprising
(iii) separating the dried potash from the entraining heated gas.

3. The process of claim 2 wherein at least some of the dried potash is combined with wet potash and reinserted back into the vertical gas suspension column.

4. The process of claim 2 wherein at least some of the separated entrained gas is returned to the gas suspension column.

5. The process of claim 1 wherein said heated gas also enters the gas suspension column in a second area location above the area where wet potash enters the gas suspension column.

6. The process of claim 1 wherein the heated gas has a temperature of from about 450° C. to about 1200° C.

7. The process of claim 1 wherein the potash material is maintained within the column for an average residence time of from about 0.5 to about 1.5 seconds.

8. The process of claim 1 wherein the wet potash material introduced into the vertical gas suspension column has an initial moisture content of from about 3 to about 6 wt. percent.

9. The process of claim 8 wherein the potash exiting the vertical gas suspension column is dried to a moisture content of from about 0.01 to about 0.1 wt. percent.

10. A process for drying potash comprising:
(i) introducing wet potash having a moisture content of from about 3 to about 6 wt. percent into a vertical gas suspension column near the bottom thereof,
(ii) transporting the potash upward through and out of the top of the gas suspension column in an entraining heated gas having a temperature of from about 450° C. to about 1200° C., for a residence time in the column of from about 0.5 to about 1.5 seconds, to thereby dry the potash to a moisture content of about 0.01-0.1 wt. percent, said heated gas entering the vertical gas suspension column through a gas inlet located near the bottom of the vertical gas suspension column and below where the material enters the column.
